(19) United States
(12) Patent Application Publication
(10) Pub. No.: US 2007/0226625 A1
(43) Pub. Date: Sep. 27, 2007

(54) System and method for unique labeling of animation display states in electronic slide presentations

(75) Inventors: Richard J. Cardone, Mahopac, NY (US); Bhavani S. Iyer, Mount Kisco, NY (US); Rose M. Williams, Wappingers Falls, NY (US)

Correspondence Address: MICHAEL J. BUCHENHORNER, 8540 S.W. 83 STREET, MIAMI, FL, 33143, US

(73) Assignee: International Business Machines Corporation

(21) Appl. No.: 11/388,482

(22) Filed: Mar. 23, 2006

(51) Int. Cl. G06F 3/00

(52) U.S. Cl. 715/732; 715/730

(57) ABSTRACT

A system and method for unique labeling of animation display states in electronic slide presentations, includes: receiving a plurality of slides, each slide comprising a plurality of animation display states; and applying a label to each animation display state wherein each label uniquely identifies an animation display state.

### CROSS-REFERENCE TO RELATED APPLICATIONS

Not applicable.

### STATEMENT REGARDING FEDERALLY SPONSORED-RESEARCH OR DEVELOPMENT

Not applicable.

### INCORPORATION BY REFERENCE OF MATERIAL SUBMITTED ON A COMPACT DISC

Not Applicable.

### FIELD OF THE INVENTION

The invention disclosed broadly relates to the field of personal productivity software that is used for electronic slide presentations and more particularly relates to uniquely labeling animation display states for slides in an electronic slide presentation.

### BACKGROUND OF THE INVENTION

Audio-visual presentations are commonplace in business settings, in academia, and in courtrooms. Electronic slide presentations software is widely used in business, academia and government to add a visual or multimedia component to speeches, talks and other verbal communication. In a typical presentation, the person who is speaking will display a succession of slides as the presentation progresses. These slides are displayed using an appropriate electronic projection or display technology, which allows audience members who are co-located with the speaker to both hear the speaker's words and see his slides. In addition, audience members who are not co-located with the speaker often use a telecommunication link to hear the speaker's voice and to receive a visual transmission of the presentation slides.

There are, however, many instances when at least some audience members have only an audio connection to the presentation site. This situation occurs, for instance, when members of the audience are geographically dispersed and a telephone conference call is used to transmit the audio portion of the presentation but not the visual portion. Whether it is for technical or economic reasons, these remote audience members may not receive a real-time, visual transmission of the presentation slides. In these situations, remote audience members are often able to view the slides during the presentation via prior arrangement, such as by receiving a copy of the presentation slides in advance or by accessing the slides from a website. Typically, remote audience members manually advance through their local copies of the presentation slides based on audio cues from the speaker. These audio cues signal when to advance to the next page.

Currently, it is often difficult to stay synchronized with the speaker when manually advancing through a slide show from a remote location. One of the main problems is that many slides employ transition effects to enhance the presentation. These transition effects, or display animation, allow the content and appearance of a slide to dynamically change after its initial display. Current implementations of electronic slide presentation software, such as Microsoft PowerPoint and Lotus Freelance, do not explicitly label animation states, so there is no way to explicitly reference these states. A remote audience member may be able to synchronize his/her slide pages to the speaker's slide pages based on the speaker's audio cues, but has no way of fully synchronizing with the display animation.

There is a need for the ability to uniquely and explicitly label animation states of electronic slide presentations.

### SUMMARY OF THE INVENTION

Briefly, according to an embodiment of the invention a method comprises receiving a plurality of slides, each slide comprising a plurality of animation display states; and applying a unique label to each animation display state wherein each label uniquely identifies an animation display state.

The method can also be implemented as machine executable instructions executed by a programmable information processing system or as hard coded logic in a specialized computing apparatus such as an application-specific integrated circuit (ASIC).

### BRIEF DESCRIPTION OF THE DRAWINGS

FIG. 1 shows the labeling of animation display states for a single slide in an electronic slide presentation, according to the known art

FIG. 2 shows the labeling of animation display states for the single slide of FIG. 1, according to an embodiment of the invention.

FIG. 3 shows the automatic updating of the display state labels upon deletion of an animation state, according to an embodiment of the invention.

FIG. 4 shows how a specific animation state of a slide may be uniquely referenced and printed, according to an embodiment of the invention.

FIG. 5 shows a block diagram of an information handling system according to an embodiment of the invention.

### DETAILED DESCRIPTION

The ability to uniquely label each distinct animation display state of a slide allows a user to conveniently reference and manipulate the display states to achieve more flexible electronic presentations. This ability to refer to each display state allows remote audience members to easily stay synchronized with a speaker while manually advancing through a local copy of the slide presentation.

Once display states have been labeled, the labels can be used to precisely refer to the observable states of a slide presentation. For example, speakers can keep remote audience members synchronized with the presentation by periodically announcing the current display state label. In addition, presentation developers can use display states to more precisely edit, print, navigate and, in general, manipulate portions of their slide presentations.

We define the animation display states of a slide as the discrete, observable states of a slide's presentation. These are also known as transition effects. The initial display of a slide is a display state and each subsequent transition effect of the slide is a separate and distinct display state. A very common technique in slide presentations is to present a listing using a succession of display states for each element of the listing. The first element of the list may be revealed in the initial display state and then subsequent elements are revealed one-by-one.

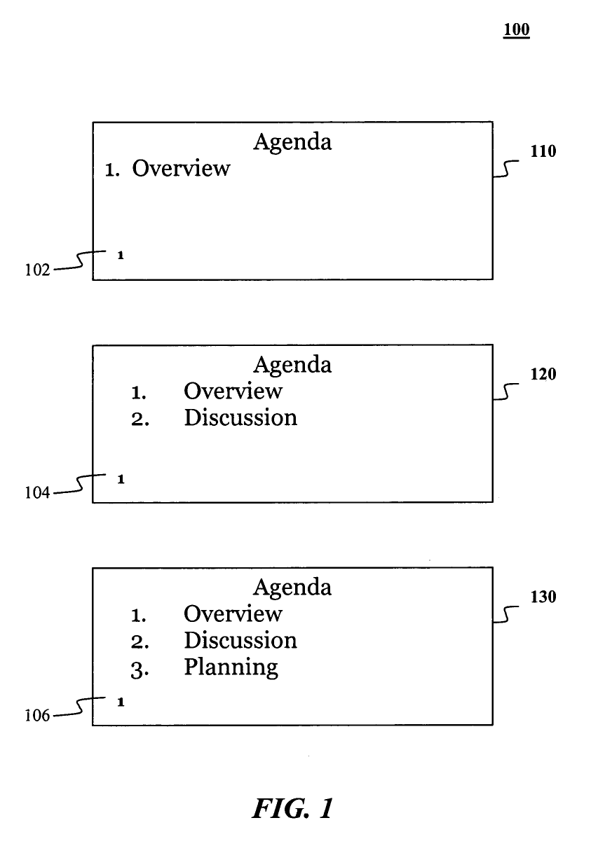

Referring to FIG. 1, there is shown a representation of multiple display states of a slide 100 in an electronic slide presentation, with the labeling according to the known art. FIG. 1 shows the slide 100 in three different animation sates. The initial display state 110 shows the first display of slide 100. Display state 120 and display state 130 show the second and third displays of slide 100, respectively. Note that the page number 102 for this slide, shown at the bottom left-hand corner, remains the same even though the slide has transitioned through three animation states.

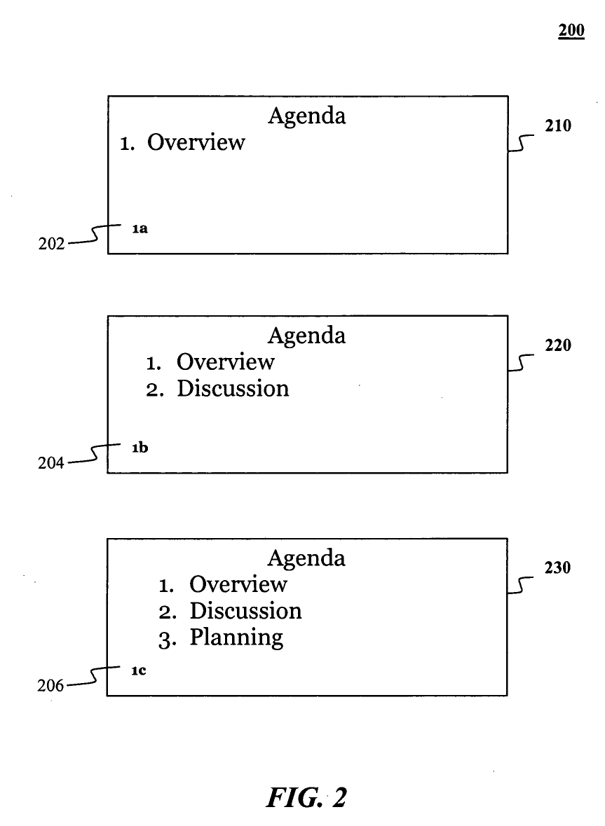

Referring to FIG. 2, there is shown a representation of multiple display states of the slide from FIG. 1, but with the unique labeling of each display state, according to an embodiment of the invention. Slide 200 is the same slide as in FIG. 1, with the same three animation display states. However, slide 200 shows the unique labeling of each display state in the lower left-hand corner of the slide. The first display state 210 shows the label “1a” in the page-number field 202. Display states 220 and 230 show sequential page numbers “1b” and “1c,” respectively. By uniquely labeling each distinct animation state of the slide, each state can be referenced separately from the other states.

Note that the page numbers in the example of FIG. 2 use the “ordinal-alpha” numbering scheme. A numbering scheme using two ordinals where the ordinals consist of a major and a minor component can also be used. We discuss a slide numbering scheme which assigns ordinals using this formula:
<O₁, O₂, O₃, . . . Oₙ>where Oᵢ<Oᵢ₊₁ for all 0<i<n
to each display state in presentation order.

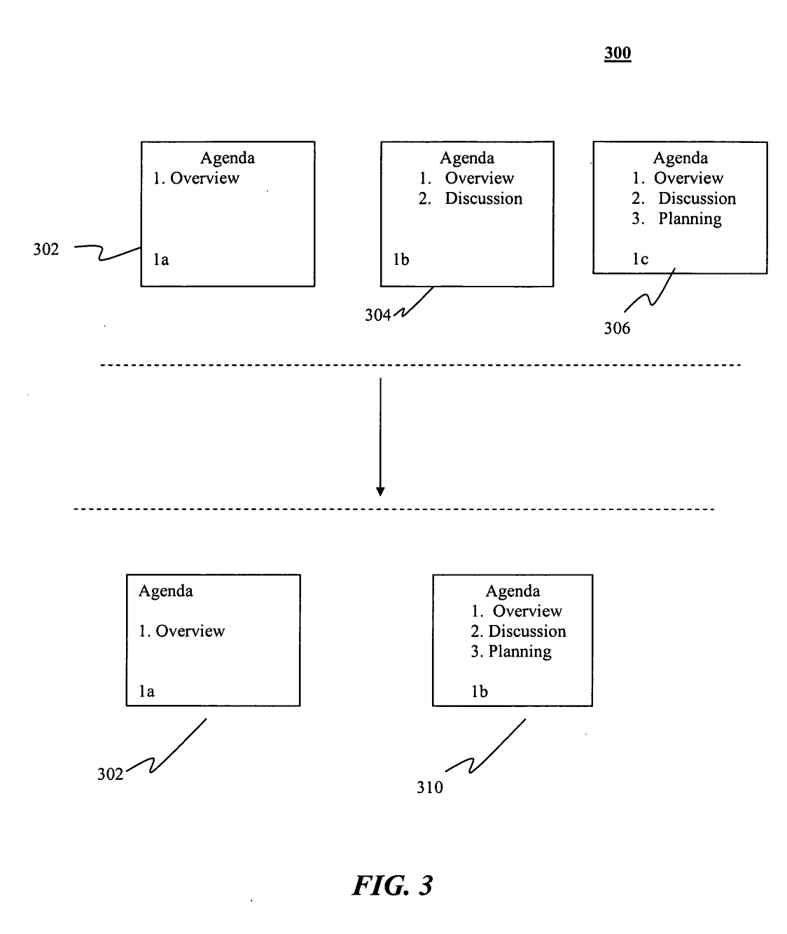

FIG. 3 shows an example of how a method according to an embodiment of the invention can be used to automatically renumber animation display states upon deletion of a display state. Display states 302, 304 and 306 are labeled 1a, 1b, and 1c, respectively. When the second display state 304 is deleted by a user the automatic renumbering is triggered. The label 1c in block 306, originally used for the third display state, is updated to label 1b as shown in block 310. Similarly, an insertion of a display state would automatically result in the renumbering of the output display states.

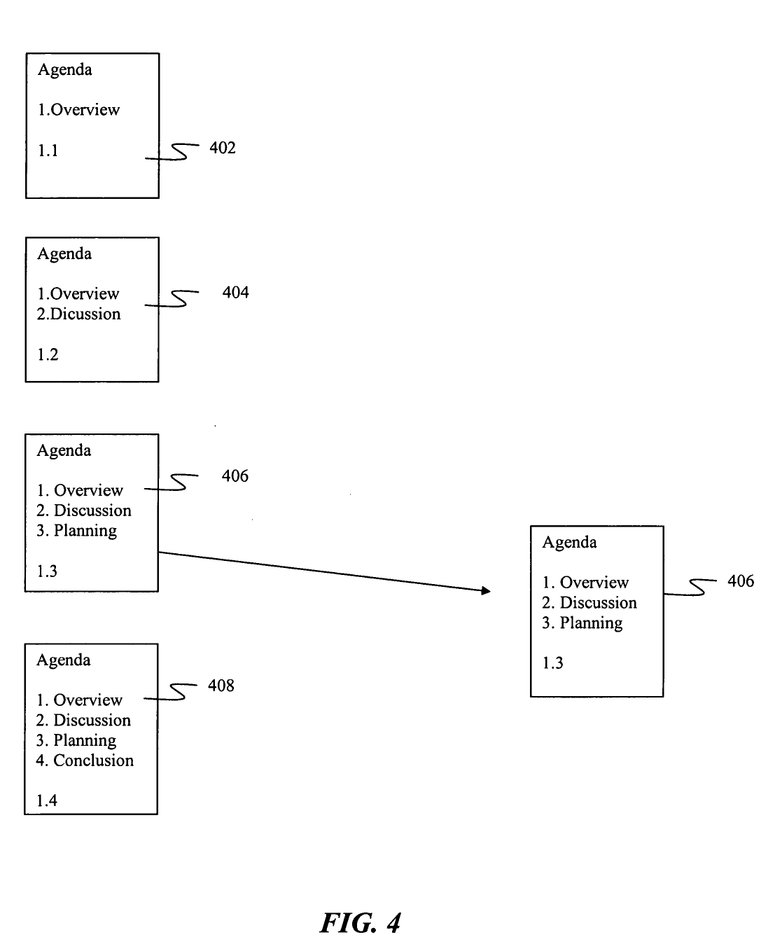

Referring now to FIG. 4 there are shown four discrete display states of a slide, 402, 404, 406, and 408, with a user selecting only one of the display states 406 for printing. Each display state is assigned a unique display state label, shown in the lower left-hand corner of the slide (1.1, 1.2, 1.3, and 1.4). When the user wishes to manipulate one of the display states, for example, by printing it, the user identifies the display state using its display state label. In this example it is “1.3.” Only the selected slide at display state “1.3” 406 is printed.

The labeling of the display states allows control over the presentation slides at a finer level of granularity than is currently possible. This fine-grained control is useful during presentation creating and editing. A preferred embodiment of display state labeling would integrate display states into the other presentation application functions, including, but not limited to, printing, navigation, exporting, copying, and slide reordering.

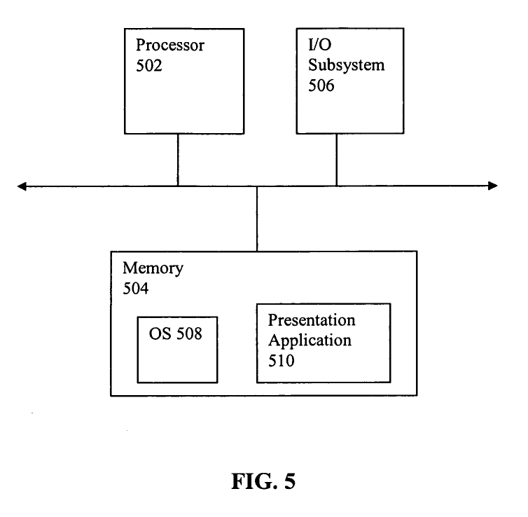

In FIG. 5 there is shown a block diagram of an information handling system 500 according to another embodiment of the invention. The system 500 comprises a processor 502, a memory 504, and an input/output (I/O) subsystem 506. The memory 504 represents either a random-access memory or mass storage. It can be volatile or non-volatile. The memory 504 comprises an operating system 508 and a presentation application 510 in which the invention may be practiced. The system 500 can also comprise a magnetic media mass storage device such as a hard disk drive.

The I/O subsystem 506 may comprise various end user interfaces such as a display, a keyboard, and a mouse. The I/O subsystem 506 may further comprise a connection to a network such as a local-area network (LAN) or wide-area network (WAN) such as the Internet.

According to another embodiment of the invention, a computer readable medium, such as a CDROM can include program instructions for operating the programmable computer 500 according to the invention. What has been shown an discussed is a highly-simplified depiction of a programmable computer apparatus. Those skilled in the art will appreciate that other low-level components and connections are required in any practical application of a computer apparatus.

Therefore, while there has been described what is presently considered to be preferred embodiments, it will be understood by those skilled in the art that other modifications can be made within the spirit and scope of the invention.

We claim:

1. A method for unique labeling of animation display states in electronic slide presentations, comprising:
receiving a plurality of slides, each slide comprising a plurality of animation display states; and
applying a label to each animation display state wherein each label uniquely identifies an animation display state.

2. The method of claim 1, wherein the label is a page number.

3. The method of claim 1, wherein the label is applied in sequential order.

4. The method of claim 1, wherein, the slide comprises a state and the initial state is a display state.

5. The method of claim 1 wherein each animation display state comprises a phase of animation and each phase is a display state.

6. The method of claim 1 wherein the page numbers use the “ordinal-alpha” numbering scheme.

7. The method of claim 6 wherein where the ordinals consist of a major and a minor component can also be used where the ordinals consist of a major and a minor component can also be used.

8. The method of claim 1 employing a slide numbering scheme which assigns ordinals using this formula:
<O₁, O₂, O₃, . . . , Oₙ>where Oᵢ<Oᵢ₊₁ for all 0<i<n
to each display state in presentation order.

9. The method of claim 8 wherein the ordinals comprise a major and a minor component, such that all display states of the same slide have a major component.

10. An information processing system comprising:
a software program for authoring interactive, computer-based presentations that contain a plurality of slides, each slide comprising one or more display states;
a presentation created using the presentation software program; and
a processor configured to assign a label to each animation display state in the presentation.

11. The system of claim 10, wherein the label is a page number.

12. The system of claim 10, wherein the label is applied in sequential order.

13. The system of claim 10, wherein, the slide comprises a state and the initial state is a display state.

14. The system of claim 10 wherein each animation display state comprises a phase of animation and each phase is a display state.

15. The system of claim 10 wherein the page numbers use the “ordinal-alpha” numbering scheme.

16. The system of claim 15 wherein where the ordinals consist of a major and a minor component can also be used where the ordinals consist of a major and a minor component can also be used.

17. The method of claim 10 employing a slide numbering scheme which assigns ordinals using this formula:
<O₁, O₂, O₃, . . . , Oₙ>where Oᵢ<Oᵢ₊₁ for all 0<i<n
to each display state in presentation order.

18. The method of claim 17 wherein the ordinals comprise a major and a minor component, such that all display states of the same slide have a major component.

19. A software program stored in a computer readable medium for authoring interactive, computer-based presentations that contain at least one slide, comprising code for:
receiving a plurality of slides, each slide comprising a plurality of animation display states; and
applying a label to each animation display state wherein each label uniquely identifies an animation display state.
